(19) United States
(12) Patent Application Publication
(10) Pub. No.: US 2007/0147624 A1
(43) Pub. Date: Jun. 28, 2007

(54) Method for controlling a hearing apparatus as a function of a switch-off period and corresponding hearing apparatus

(75) Inventor: Eghart Fischer, Schwabach (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS AUDIOLOGISCHE TECHNIK GmbH

(21) Appl. No.: 11/637,466

(22) Filed: Dec. 12, 2006

(30) Foreign Application Priority Data
Dec. 20, 2005 (DE) 10 2005 061 002.1

(51) Int. Cl. H04R 5/00; H04R 25/00

(52) U.S. Cl. 381/23.1

(57) ABSTRACT

The sensitivity fluctuations of a hearing device wearer are to be catered for in an improved manner. A control method for a hearing device or another hearing apparatus is thus provided, by means of which a period of time is detected during which the hearing apparatus is switched off. At least one parameter of the signal processing of the hearing apparatus is changed as a function of the detected period. In particular, when the hearing apparatus is switched on again, the amplification is adjusted as a function of the switch-off duration. An acceptable volume can thus be achieved for instance when the device is switched on for the first time in the morning.

### CROSS REFERENCE TO RELATED APPLICATIONS

This application claims priority of German application No. 10 2005 061 002.1 filed Dec. 20, 2005, which is incorporated by reference herein in its entirety.

### FIELD OF THE INVENTION

The present invention relates to a method for controlling a hearing apparatus, in particular a hearing device, by changing a parameter of a signal processing of the hearing apparatus as well as switching the hearing apparatus on/off. Furthermore, the present invention relates to a corresponding hearing apparatus.

### BACKGROUND OF THE INVENTION

With hearing devices and other hearing apparatuses such as implants, headsets and suchlike, the amplification can be adjusted manually or controlled automatically. The automatic control is carried out for instance on the basis of amplification characteristic curves as a function of an input level. Furthermore, the amplification can also be changed by corresponding hearing programs.

The amplification can however also be automatically changed in so-called acclimatization stages. This is used in order to gradually accustom a hearing-impaired person to wearing a hearing device. The amplification is gradually increased over the course of a number of weeks as a function of the time which has elapsed since the hearing device was first supplied.

Publication DE 195 42 961 C1 further discloses a circuit for operating a hearing device, having at least one variable operating parameter. Provision is made here for a control device, with the operating parameter setting of the initial situation and the target situation being determined in a storage arrangement and the operating parameter/s according to the setting of the initial situation being able to be adjusted over a specific time interval to the operating parameters according to the setting of the target situation, by means of the control device.

Furthermore, patent application DE 100 48 341 C1 discloses a method for operating a hearing aid device. To automatically select a program, the hearing aid device recognizes whether it is located in the vicinity of an external transmitter. The transmitter generates a transmitter-specific signal, so that an assignment of different transmitters can take place. Furthermore, the current time and day of the week can also influence the choice of the active hearing program in the hearing aid device.

Experience has shown that every normal-hearing person and every hearing-impaired person is aware that the ear is more sensitive in the morning than in the evening for instance, since, in the course of the day, it was already exposed to a plurality of acoustic sounds. A type of “day acclimatization” thus occurs.

### SUMMARY OF THE INVENTION

The object of the present invention thus consists in catering for the sensitivity fluctuations of the ear in the signal processing of a hearing apparatus.

In accordance with the invention, this object is achieved by a method for controlling a hearing apparatus, in particular a hearing device, by changing a parameter of a signal processing of the hearing apparatus and switching the hearing apparatus on/off, as well as detecting a period during which the hearing apparatus is switched off and automatically changing at least one parameter of the signal processing as a function of the detected period.

Furthermore, a hearing apparatus is provided in accordance with the invention, in particular a hearing device, having a signal processing facility, the parameters of which can be changed, and a switching facility for switching the hearing apparatus on/off, as well as a time monitoring facility for detecting a period, during which the hearing apparatus is switched off by the switching facility, with at least one parameter of the signal processing facility being able to be automatically changed by the signal processing facility as a function of the detected period.

In accordance with the invention, the sensitivity of the ear is advantageously considered as a function of the stimulus history. Consequently, an adjustment can be made to the acceptable volume when switching the device on for the first time after waking up. The full volume is then only achieved after a specific wear time, when the hearing is less sensitive.

After switching the hearing apparatus on, the at least one parameter is preferably automatically changed from one initial value to a predetermined final value, discontinuously or continuously, by means of the signal processing facility. The continuous change or small jumps allow the parameter change to be barely noticed by the hearing device wearer. Nevertheless, the target value is reached after a specific period. In particular, the parameter can be changed from the initial value to the final value within an hour. This time frame is typically sufficient to allow for the initial high sensitivity of the ear.

The at least one parameter can relate for instance to the amplification, the sound, the efficiency of an interference noise suppression or a maximum level. All parameters relating to the sensitivity of the hearing are thus intended to be variable in accordance with the invention, as a function of the switch-off period.

It is particularly advantageous if, when the hearing apparatus is switched on, it is activated with a predetermined minimal amplification after a switch-off period of at least six hours. By way of example, by switching the hearing device off overnight, it is thus possible to ensure a specific minimum use of the hearing device when switching the hearing device on, without resulting in interfering adverse effects.

Furthermore, a minimum switch-off duration can be predetermined for the signal processing facility so that a switch-off duration below the minimum switch-off duration does not result in a change in the at least one parameter. In particular, a brief switching-off of the hearing device does then not result in a change in the amplification, since a brief period of rest of the ear does not result in a substantial sensitivity change.

In a further developed embodiment of the inventive hearing apparatus, a current time of day can be provided with the aid of the time monitoring facility and the at least one parameter or another parameter of the signal processing are changed as a function of the current time of day. Even more allowance can thus be made for an individual diurnal rhythm.

The hearing apparatus can also comprise a brightness sensor facility, so that the at least one parameter or another parameter of the signal processing can be changed as a function of the current brightness. In this way too the diurnal rhythm of the wearer of the hearing apparatus can be better considered in the signal processing. In a concrete embodiment, the time monitoring facility for time measurement comprises a capacitor, which is discharged by way of a light-dependent resistor. A brightness sensor facility of this type can be realized in a relatively cost-effective manner.

### BRIEF DESCRIPTION OF THE DRAWINGS

The present invention is now described in further detail with reference to the appended drawings, in which;

FIG. 1 shows a layout of an inventive hearing device and

FIG. 2 shows amplification curves for different switch-off periods of a hearing device.

### DETAILED DESCRIPTION OF THE INVENTION

The embodiments illustrated in more detail below represent preferred exemplary embodiments of the present invention.

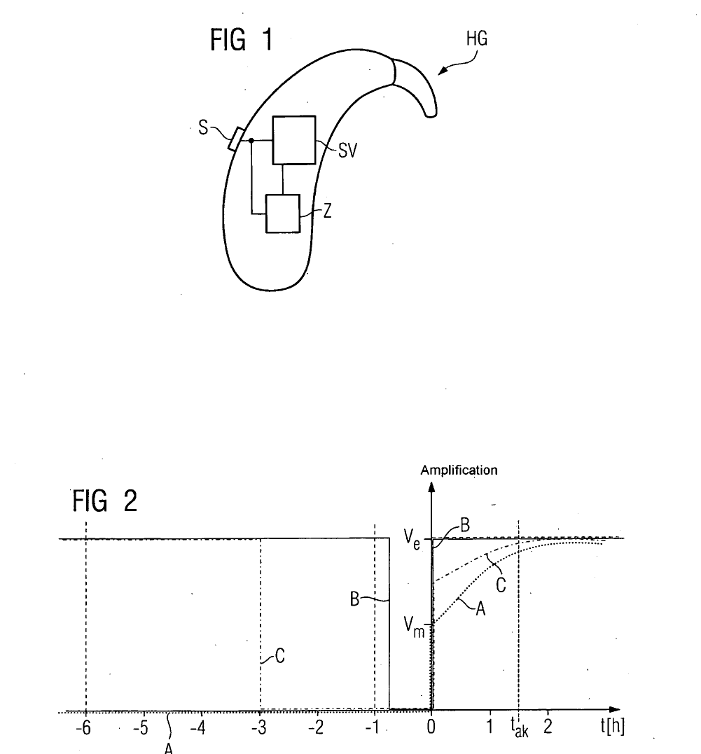

The hearing device reproduced schematically in FIG. 1 has a signal processing facility SV. A switch S for switching the hearing device HG on and off is connected thereto. Furthermore, a time monitoring facility Z is provided in the hearing device HG, which registers a switch-off of the hearing device by means of the switch S. It supplies a corresponding signal to the signal processing facility SV so that the amplification factor can be changed there for instance as a function of the switch-off period of the hearing device.

The exemplary hearing device thus enables a “daily acclimatization” of the hearing device, which is basically independent of a hearing program. Instead this “daily acclimatization” of the program selection is overlaid on the program selection. Furthermore, the acclimatization is also not dependent on an absolute time of day, but is instead, in its basic form, exclusively dependent on the switch-off period. For refinement purposes, an additional dependency on the current time of day can certainly be provided.

The functionality of an inventive hearing device is now described in more detail with the aid of the following examples. Overnight, the hearing device is normally taken off the ear and switched off. This switch-off is now registered by the hearing device and the duration of the switched-off status is measured. When the device is switched on again, the initial amplification is selected to be lower, the longer the device has been switched off.

Overnight, the device is typically switched off for more than six hours. FIG. 2 shows the switch-off status by means of a dotted line A with the amplification 0 up to point in time 0, at which the hearing device is switched on. If the device is switched off for more than six hours, when the device is switched on again the amplification is set to a minimal amplification value Vₘ. The amplification then increases, as does line A, to amplification value Vₑ within approximately 1.5 hours. The acclimatization duration tₐₖ thus corresponds here to approximately 1.5 hours. It can however also amount to 1 hour, 0.5 hours or less for instance. Similarly, it can be higher, as desired.

If the device is only switched off for a short period of time, such as only 0.75 hours, according to the solid line B in FIG. 2 for instance, the initial amplification thus corresponds to final value Vₑ after the device is switched on again according to the curve gradient B. This allows for the psychoacoustic fact that the sensitivity of the ear does not change substantially after a brief switching-off and/or the short period of rest. On reactivation with a scarcely changed amplification, the assumption is thus made that this period does not involve a sleep phase of the hearing device wearer.

If the switch-off phase is longer than 1 hour and less than 6 hours, the amplification at the beginning when the device is switched on again can lie between the minimum amplification Vₘ and the final amplification Vₑ. One example of this is plotted in FIG. 2 with the dotted line C. Here too the final amplification is also approximately reached after the acclimatization period tₐₖ.

Embodiment variants can consist for instance of the acclimatization time tₐₖ being changed. It can for instance be 0.5 hours, 1 hour or more.

A further embodiment basically consists in the amplification being at the minimum amplification Vₘ when the device is switched on again once a minimum switch-off duration has been exceeded. The acclimatization time can be automatically adjusted as a function of the switch-off period. This means that the acclimatization runs more slowly during a long switch-off period than during a short switch-off period.

With a further embodiment, the time monitoring facility Z has a clock or a corresponding receiver in order to provide the current time of day. In this way, the hearing device wearer can adjust the amplification or another parameter to his/her biorhythm. If the sensitivity, which is subjectively perceived by the hearing device wearer, is at its greatest in the afternoon for instance, the amplification can, at this time, be automatically slightly reduced.

An evaluation of the ambient brightness can be included in the time measurement as a further variant. By way of example, the switched-off time of the hearing device can then only be considered as “valid” if the hearing device is in darkness. Naturally the switch-off time and the brightness value can be linked to any given function for the purpose of determining a gain reduction.

The duration of the switched-off status is measured for instance by means of a slowly discharging capacitor. This is advantageous in that a battery change carried out in the switched-off time has no influence on the time measurement. The inclusion of the brightness could then be realized for instance by a light-dependent resistor in the discharge current circuit of the capacitor.

1.-14. (canceled)

15. A method for controlling a hearing apparatus, comprising:
switching the hearing apparatus off;
detecting a switch off period during which the hearing apparatus is switched off; and
automatically changing a parameter of a signal processing unit of the hearing apparatus as a function of the detected switch off period after the hearing apparatus is switched on.

16. The method as claimed in claim 15, wherein the parameter of the signal processing unit is automatically changed discontinuously from an initial value to a predetermined final value after the hearing apparatus is switched on.

17. The method as claimed in claim 16, wherein the parameter of the signal processing unit is changed from the initial value to the final value within an hour.

18. The method as claimed in claim 15, wherein the parameter of the signal processing unit is automatically changed continuously from an initial value to a predetermined final value after the hearing apparatus is switched on.

19. The method as claimed in claim 18, wherein the parameter of the signal processing unit is changed from the initial value to the final value within an hour.

20. The method as claimed in claim 15, wherein the parameter of the signal processing unit is a parameter related to a hearing sensitivity.

21. The method as claimed in claim 20, wherein the parameter of the signal processing unit is selected from the group consisting of: amplification, sound, efficiency of interference noise suppression, and maximum level.

22. The method as claimed in claim 15, wherein the hearing apparatus is activated with a predetermined minimal amplification when the hearing apparatus is switched on after the hearing apparatus is switched off for more than six hours.

23. The method as claimed in claim 15, wherein a minimum switch off period is predetermined so that the parameter of the signal processing unit is not changed if the detected switch off period is less than the minimum switch off period.

24. The method as claimed in claim 15, wherein a current time of a day is monitored and the parameter of the signal processing unit is changed as a function of the current time of the day.

25. The method as claimed in claim 15, wherein the parameter of the signal processing unit is changed as a function of a current brightness.

26. A hearing apparatus, comprising:
a signal processing unit;
a switching unit that switches the hearing apparatus on and off;
a time monitoring unit that detects a time duration during which the hearing apparatus is switched off; and
an adjusting unit arranged in the signal processing unit that automatically adjusts a parameter of the signal processing unit as a function of the detected time duration.

27. The hearing apparatus as claimed in claim 26, wherein the parameter of the signal processing unit is automatically changed discontinuously from an initial value to a predetermined final value after the hearing apparatus is switched on again.

28. The hearing apparatus as claimed in claim 26, wherein the parameter of the signal processing unit is automatically changed continuously from an initial value to a predetermined final value after the hearing apparatus is switched on again.

29. The hearing apparatus as claimed in claim 26, wherein the parameter of the signal processing unit is selected from the group consisting of: amplification, sound, efficiency of interference noise suppression, and maximum level.

30. The hearing apparatus as claimed in claim 26, wherein the time monitoring unit monitors a current time of a day and the parameter of the signal processing unit is changeable as a function of the current time of the day.

31. The hearing apparatus as claimed in claim 26, wherein the time monitoring unit comprises a capacitor which is discharged by a light dependent resistor.

32. The hearing apparatus as claimed in claim 26, further comprising a brightness sensor so that the parameter of the signal processing unit is changeable as a function of a current environmental brightness.

33. The hearing apparatus as claimed in claim 26, wherein the hearing apparatus is a hearing aid device worn by a human.
